(19) United States
(12) Patent Application Publication
(10) Pub. No.: US 2012/0323990 A1
(43) Pub. Date: Dec. 20, 2012

(54) EFFICIENT STATE RECONCILIATION

(75) Inventor: Christopher Robert Hayworth, Martinez, CA (US)

(73) Assignee: Microsoft Corporation, Redmond, WA (US)

(21) Appl. No.: 13/161,350

(22) Filed: Jun. 15, 2011

(51) Int. Cl. G06F 15/16

(52) U.S. Cl. 709/203

(57) ABSTRACT

The embodiments described herein generally relate to methods and systems for using a token as a bi-directional parameter of a long polling request for state updates. A client polls a server for state updates, in which updates may be the result of a server event. Server state data is hashed to generate a token/hash representing the current state data. The server compares this token/hash to the token/hash received from the client in the polling request. If the tokens differ, the server sends the actual state data with the server token to the client. By using tokens as request parameters, unnecessary state updates are avoided, and client/server synchronization is achieved more quickly by restricting the pushing of data to state updates. Further, the client may force a response to a poll by sending an empty or random/default value for the token request parameter.

### BACKGROUND

The use of polling by browsers, such as Web browsers, to request data from servers, such as Web servers, has become increasingly prevalent. In data exchanges between Web browsers and Web servers, a Web browser or client typically sends requests to a server for content updates in an attempt to achieve synchronization between the client and server. In response to each request, a server sends a complete response. By sending a complete response each time, such request and response exchanges unnecessarily consume network resources where data is sent in response to a client request even where no updates have been made to such data at the server. Further, increasing demand for Web server content and updates from numerous browsers communicating with a single Web server causes strain on system resources and resulting latencies which compounds inefficiencies in trying to reconcile client content with server updates.

In attempting to more efficiently exchange content between browsers and servers, long polling, such as Hypertext Transfer Protocol (HTTP) long polling, enables Web servers to push data to a browser when an event at the server, or other event triggering server activity, occurs. With long polling, a browser or client sends a long polling request to a server to obtain events at the server. Such long polling techniques are sometimes referred to as part of the “Comet” Web application model for using long-held HTTP requests to push data from a server to a browser without the browser expressly requesting such data. In typical long-polling or Comet implementations, client requests are held by the server until a server event occurs. When an event occurs, the server sends new data to the browser in a complete response. Thus, the request to the server persists until the server has new data to send. Upon receiving a response, the browser sends another request to the server to wait for a subsequent event. However, unnecessary updates still occur and out-of-sync clients experience latencies in reconciling content with the server because each server response corresponds to a server event. Some of these server events are unnecessary to achieve synchronization, such as when the client is already at the same state as the current state of the server when the server begins sending new data based on intermediate events. Consequently, where a client gets out-of-sync due to a disconnection to the internet, for example, the client tries to catch up to the current server state by processing potentially numerous response messages with data on prior server events. It may be exceedingly difficult for a slow client to keep in sync with a fast-changing server because the client is often still processing prior events while the server has been making further changes. Further, where a client lags behind a server, some interim events may be ignorable for the client to reach synchronization with the server. However, data pushing based on server events pushes events to the client regardless of their lack of use to the client in achieving ultimate synchronization with the server's current state.

Although specific problems have been addressed in this Background, this disclosure is not intended in any way to be limited to solving those specific problems.

### SUMMARY

Embodiments generally relate to pushing state data at a server to a client via a token mechanism. Specifically, a token is used as a multi-directional, e.g., bi-directional, parameter of a long polling request for state updates to achieve efficient state reconciliation between a server(s) and a client(s). A server, such as a Web server, receives a state update. For example, the server may receive a state update from an application comprising a document editing session, in which changes are made to a co-authoring document, for example, are sent to the server or to a management module executing on the server. The management module, in turn, alters the state of the server to reflect the received state update. The server then computes a digest/hash of the state that is desired to be synchronized between the server and the client. In so doing, a token is generated comprising the hash value. Upon receiving a request from the client for any state updates, the server compares a token received with the client request to the token on the server to determine if the tokens differ. If the tokens do not differ, the client has the current state of the data and does not need to further reconcile its content with the server. Instead, the server holds onto the client request, i.e., long-held request, with the received token until a change in the server state occurs. However, if the tokens differ, the client does not have the current state. The server then sends the actual state with the current token on the server to the client. In embodiments, the client may then update its data and store the received token for sending with a subsequent request for state updates. As noted, in embodiments, the request from the client is a long-held request as part of a long polling technique. In further embodiments, the long polling by the client comprises HTTP long polling. In other embodiments, regular polling is used.

In additional embodiments, the client may force a server to respond immediately to a request for state updates. In other embodiments, the server is forced to respond in a predetermined time period or when the availability of system resources determines that the server may respond, for example. In forcing the server to respond, the client sends an empty value for the token value as a request parameter in its long-held request to the server, according to an embodiment. In another embodiment, the client sends a random/default value for the token value as a request parameter in its long-held request to the server, in which the random/default value is a value that is unlikely to match the current token value on the server. An empty or random/default value causes the server to determine that the token on the server and the received token from the client do not match. Consequently, the server replies immediately by sending its state data and the token on the server to the client. The client is thus able to obtain an immediate response to its polling request without waiting for the server to periodically push data back or for a server event to occur.

This Summary is provided to introduce a selection of concepts in a simplified form that is further described below in the Detailed Description. This Summary is not intended to identify key or essential features of the claimed subject matter, nor is it intended to be used in any way as to limit the scope of the claimed subject matter.

### BRIEF DESCRIPTION OF THE DRAWINGS

Embodiments of the present disclosure may be more readily described by reference to the accompanying drawings in which like numerals refer to like items.

FIG. 1A illustrates an example logical representation of an environment or system for using a token as a parameter of a long-held polling request for state updates, in accordance with embodiments disclosed herein.

FIG. 1B depicts an example logical representation of a further type of environment or system, e.g., a three-layer architecture, for using a token as a parameter of a long-held polling request for state updates, in accordance with embodiments disclosed herein.

FIG. 2A shows an example logical representation of software modules for using a token as a parameter of a long-held polling request for state updates in the example environments shown in FIGS. 1A and 1B, in accordance with embodiments of the present disclosure.

FIG. 2B depicts an example logical representation of an environment or system for using a token/hash as a request parameter and as a response return value along with the state, in accordance with embodiments of the present disclosure.

FIG. 3 illustrates a flow diagram depicting the operational characteristics of a process for determining whether to push state updates, in accordance with embodiments of the present disclosure.

FIG. 4 shows a flow diagram illustrating the operational characteristics of a process for comparing tokens to determine if the state has changed, in accordance with an embodiment of the present disclosure.

FIG. 5 depicts a flow diagram illustrating the operational characteristics of a process for forcing a response to a request for state updates, in accordance with embodiments of the present disclosure.

FIG. 6 illustrates a flow diagram depicting the operational characteristics of a process for receiving an empty or random/default token value to push data, in accordance with an embodiment of the present disclosure.

FIG. 7 depicts an example computing system upon which embodiments of the present disclosure may be implemented.

### DETAILED DESCRIPTION

This disclosure will now more fully describe example embodiments with reference to the accompanying drawings, in which specific embodiments are shown. Other aspects may, however, be embodied in many different forms, and the inclusion of specific embodiments in this disclosure should not be construed as limiting such aspects to the embodiments set forth herein. Rather, the embodiments depicted in the drawings are included to provide a disclosure that is thorough and complete and which fully conveys the intended scope to those skilled in the art. Dashed lines may be used to show optional components or operations.

Embodiments generally relate to using a token mechanism with long polling to allow a server to push data to a client or browser based on a change in the state of the data, as opposed to a server event. Sending server messages to the client with state updates only avoids unnecessary exchanges of data and thus improves system efficiencies. For example, in a co-authoring presentation application, in which a presenter is sharing a presentation slideshow with various users communicating from their respective Web browsers in a Web conference environment, the presenter may start the slideshow on slide #1. Client A at Web browser A may have the current state, in which it is simultaneously displaying slide #1 through the user interface module of its computer. The presenter next switches to slide #5, for example, to answer a question from another audience member. In the meantime, Client A becomes disconnected from the Web conference. The presenter then switches to slide #3, and then returns to slide #1. Upon reconnecting, Client A desires the current state. Through long polling based on a token mechanism, the server, or management module residing on the server, determines that Client A has the current state because the presenter has switched back to slide #1. Therefore, no state updates are sent to Client A. On the other hand, with previous server-event-driven polling techniques, Client A would first be sent updates relating to slide #5 and slide #3 before finally synchronizing with the server at slide #1. Further, by the time that Client A gets back to slide #1, the presenter may have already switched to slide #2, for example. Long polling via a token mechanism to restrict server responses to state updates thus results in numerous benefits, including, for example, communicating data to the client browser faster and cheaper and making the data between the client and server more consistent and in sync.

In an embodiment, a server, such as a Web server, receives a state update, such as from an application comprising a document editing session. In embodiments, such updates are received at a manager, or management module, residing on the server. The state at the server is then changed to reflect the received state update. This state is hashed to generate a token which comprises the hash value of the state. According to embodiments, when the server receives a client request for any state updates, e.g., a long-held request, the server compares a token received from the client with the request to the token on the server. If the tokens match, the client is in sync with the server, e.g., the client has the current state of the data. The server therefore holds onto the client request and received token. On the other hand, if the tokens differ, the client is out of sync with the server and does not have the current state of the data. The server therefore pushes the actual state with the current token on the server to the client. In embodiments, the client may then update its data. In further embodiments, the client also stores the received token for sending with a subsequent request for state updates. According to embodiments, the client and server therefore maintain a persistent connection for the exchange of data, and state data is only sent to the client when it is determined that the client does not have the current state of the data. As noted, in embodiments, the request from the client is a long-held request as part of a long polling technique. In further embodiments, the long polling by the client comprises HTTP long polling. In other embodiments, regular polling is used.

Through the use of the token mechanism, the server is thus able to compare the tokens, as opposed to the entire data set, to determine if the state has changed. A comparison of token values, as opposed to state data itself, thus significantly increases the server response time to client requests. Further, unnecessary state updates are avoided because the server sends the current state to the client, as opposed to intervening events that may not have impacted the resulting current state of the server, at the time of determining that differences in state occur. Embodiments thus provide for the data of the server response to be restricted to state updates as opposed to server events. As a result, consistencies between the client and server content are improved and data is communicated faster and with less needless consumption of system resources.

Further, with long polling, clients have a quick way to examine if the state has changed from the previous receipt of state data. In embodiments, clients may merely compare tokens, or token values, instead of state data which may likely be larger and/or present more complexities in determining the actual state.

According to additional embodiments, the client may force an immediate response from a server to a request for state updates by sending an empty or random/default value for the token value in its long-held polling request to the server. In other embodiments, the response is forced in a predetermined time period or when the availability of system resources allows the server to respond, for example. An empty or random/default value causes the server to determine that the token on the server and the received token differ. As a result, the server replies immediately by sending its state data and the token on the server to the client. The client is thus able to obtain an immediate response without waiting for the next usual server push. The client may thus more quickly synchronize with the server, such as when a client first initiates a connection with the server or when the client has been disconnected or otherwise lagging behind the server content changes. Sending an empty or random/default value for the token thus enables the server endpoint to logically switch from long polling to regular polling.

Further, as some embodiments show, the use of tokens forces clients to not rely on the timing of server responses. Therefore, a server has the option of replying immediately even if the token received from a client with a long polling request matches the token on the server. Such flexibility is useful, for example, where the server(s) is shutting down or doing some other act where the server(s) does not want to have open connections.

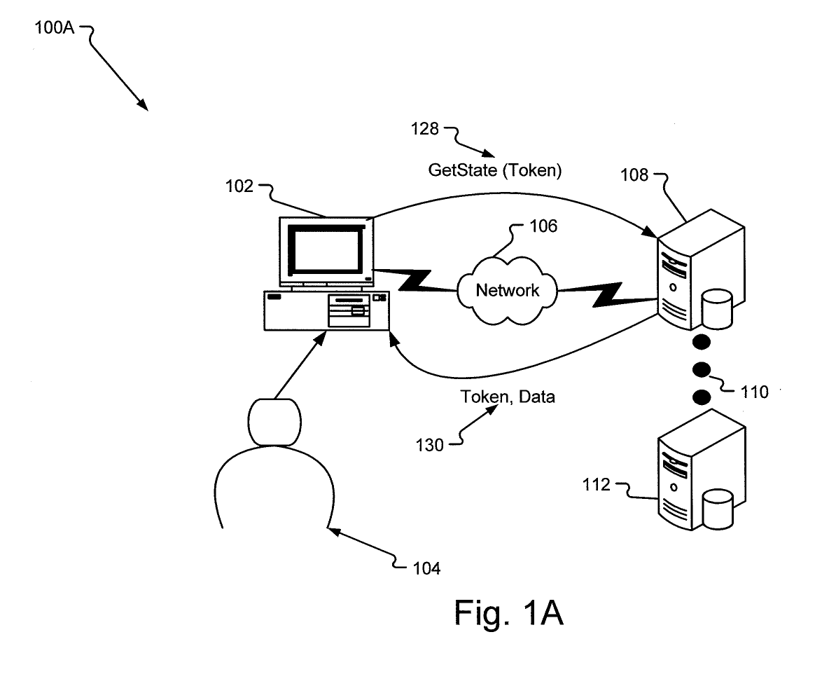

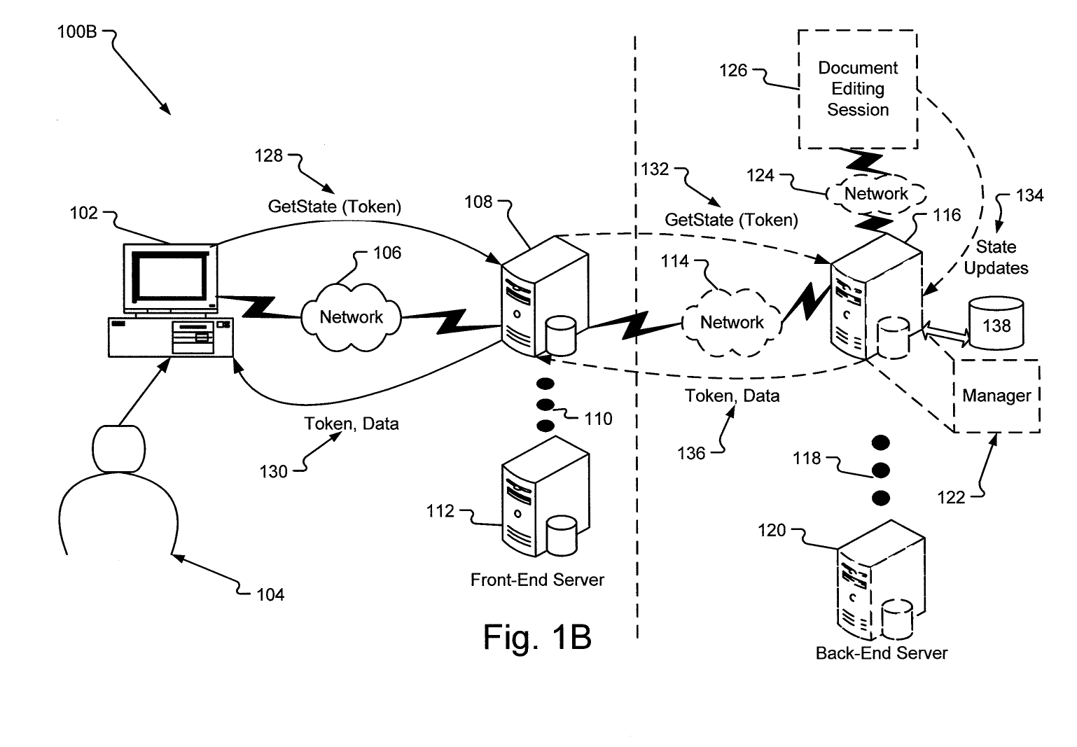

Turning to FIG. 1A, an example logical environment or system 100A for using a token as a parameter of a long-held polling request for state updates is shown in accordance with embodiments of the present disclosure. Client computer 102 sends a request for state updates 128 to server 108. In an embodiment, server 108 is referred to as a front-end server. In embodiments, any number of servers may be used, as shown by ellipsis 110 and server 112. Client computer 102 executes a browser, such as a Web browser, for viewing of Web pages, for example, by a user 104. Such Web pages or documents or other data, for example, are displayed or output to a user interface through a user interface module executing on client computer 102. The request for state updates 128 sent from client computer 102 to server 108 is transmitted over network 106. The request for state updates 128 comprises a token as a parameter. The token in request 128 is a hash of the state at the server as understood by the client. For example, in an embodiment, the client may have received the token in a response, by the server, to a previous request for a state update. In another embodiment, the token value in request 128 may comprise an empty or random/default value or any type of “dummy” value. Such empty or random/default value or dummy value may be included when the client does not know the value, such as when the client is first initiating contact with the server, according to an embodiment. In another embodiment, an empty or random/default value or dummy value is used purposefully by the client (while ignoring the correct token value) to force the server to reply immediately to the client's request for state updates. In another embodiment, the server reply occurs as soon as the server is able to respond. In yet another embodiment, the server reply occurs in a predetermined time period set by the server. In a further embodiment, the server reply occurs in a predetermined time period set by the client. While request 128 is shown in FIG. 1A as comprising the HTTP request, “GetState,” any type of request in accordance with embodiments of the present disclosure may be used without departing from the spirit and scope of the present disclosure.

In response to receiving the request for state updates with token 128, server 108 determines whether the current token on the server matches the received token. If the tokens do not match, server 108 responds by sending the token value on the server with the state data 130 to client 102.

While FIG. 1A illustrates a message exchange between client computer 102 and server 108, FIG. 1B also shows an additional optional environment 100B in which server 108 is a front-end server in communication with a back-end server 116, according to further embodiments of the present disclosure. FIGS. 1A and 1B illustrate example logical environments upon which the functionality of the present disclosure may be implemented. Logical environments 100A and 100B are not limited to any particular implementation and instead embody any computing environment upon which the functionality of the environment described herein may be practiced. FIGS. 1A and 1B are offered for purposes of illustration.

Turning to FIG. 1B, while back-end server 116 is illustrated, multiple back-end servers may be used in accordance with embodiments disclosed herein and as shown by ellipsis 118 and back-end server 120. Components in the back-end environment are shown with dashed lines as optional components because some embodiments provide for long polling via a token mechanism occurring with client computer 102 and server 108 with no back-end server(s), as depicted in FIG. 1A. In the possible embodiment involving back-end servers 116-120 shown in FIG. 1B, server 108 is referred to as a front-end server, in which front-end server 108 (or 110, 112) communicates the request for state updates 132 originally received from client 102 to back-end server 116. As shown, multiple back-end servers may be used as shown by ellipsis 118 and back-end server 120, according to embodiments of the present disclosure. The request for state updates 132 comprises a token as a parameter of the request. While request 132 is shown in FIG. 1B as comprising the HTTP request, “GetState,” any type of request in accordance with embodiments of the present disclosure may be used without departing from the spirit and scope of the present disclosure.

In embodiments, upon receiving the request for state updates 132 with the token from the client, back-end server 116 compares the token on the server to the received token. In an embodiment, a manager (or management) module or component 122 executing on server 116 (or servers 118, 120) compares the token on the server with the token received from the client. While FIG. 1B refers to module 122 as a “Manager” module or component, this module or component may be referred to by any name without departing from the spirit and scope of the present disclosure. Further, the management module 122 may comprise software according to embodiments, while other embodiments provide for the component to be hardware for computer programming code for executing the methods described herein.

In an embodiment, server 116 and/or manager module 122 computes the value of the token on the server by hashing the state at the server. State updates 134 are received from an application comprising, for example, a document editing session 126, according to embodiments, over network 124. In other embodiments, state updates are received from another server, client computer, computer system, workflow executing on another computing system, and/or Web browser, etc. Document editing session 126 is offered for purposes of example only to illustrate the teachings of the present disclosure. The token value may be stored in database 138 in accordance with embodiments of the present disclosure or, in other embodiments, the token value may be stored in a database(s) attached to server 116 (or 118, 120), for example.

Server 116 and/or manager module 122 determines if the token received from the client 132 differs from the token on the server 116. If the values differ, server 116 responds to the client request by sending data with the token on the server 136 over network 114 to front-end server 108. Upon receiving the data and token, front-end server 108 then sends the state data and token 130 over network 106 to client 102, according to an embodiment. In another embodiment, front-end server 108 does not send the data and token upon receiving them but, instead, waits a period of time. Such period of time is predetermined according to embodiments or depends on available system resources in other embodiments.

In an embodiment, the data 136 (or 130) sent from server 116 (and/or server 108) comprises state data reflecting a state update(s). In other embodiments, the data 136 (or 130) from server 116 (and/or server 108) comprises data in addition to the state updates. While embodiments provide for the tokens in requests 128 and 132 to be included as parameters to the requests for state updates, in further embodiments, the tokens sent with respect to requests 128 and 132 are sent separately from the requests. Further, while embodiments provide for the token on the server to be sent with the state data in response 136 and 130, other embodiments provide for the token on the server to be sent separately from the data.

Logical environments 100A and 100B are not limited to any particular implementation and instead embody any computing environment upon which the functionality of the environment described herein may be practiced. For example, any type of client computer 102 understood by those of ordinary skill in the art may be used in accordance with embodiments. Further, networks 106, 114, and 124, although shown as individual single networks may be any types of networks conventionally understood by those of ordinary skill in the art. In accordance with an embodiment, the network may be the global network (e.g., the Internet or World Wide Web, i.e., “Web” for short). It may also be a local area network, e.g., intranet, or a wide area network. In accordance with embodiments, communications over networks 106, 114, and 124 occur according to one or more standard packet-based formats, e.g., H.323, IP, Ethernet, and/or ATM.

Further, any conceivable environment or system as understood by those of ordinary skill in the art may be used in accordance with embodiments of the present disclosure. FIGS. 1A and 1B are offered as examples only for purposes of understanding the teachings of the embodiments disclosed herein. For example, FIG. 1B shows servers 108-112 and 116-120. However, embodiments also cover any type of server, separate servers, server farm, server cluster, or other message server. Further yet, FIGS. 1A and 1B show client computer 102. However, any type of small computer device may be used as is understood by those of ordinary skill in the art without departing from the spirit and scope of the embodiments disclosed herein. Although only one client computer 102 is shown, for example, another embodiment provides for multiple small computer devices to communicate with servers 108-112 and/or 116-120. In an embodiment, each small computer device communicates with the network 106, or, in other embodiments, multiple and separate networks communicate with the small computer devices. In yet another embodiment, each small computer device communicates with a separate network. Indeed, environments or systems 100A and 100B represent valid ways of practicing embodiments disclosed herein but are in no way intended to limit the scope of the present disclosure. Further, the example network environments 100A and 100B may be considered in terms of the specific components described, e.g., server, client computer, etc., or, alternatively, may be considered in terms of the analogous modules corresponding to such units.

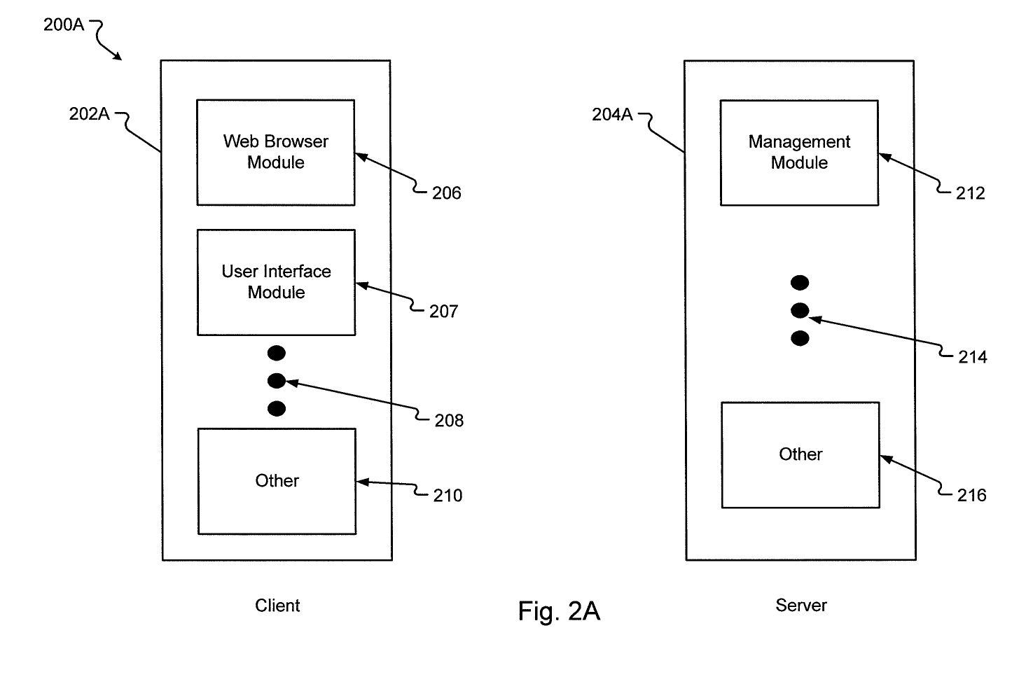

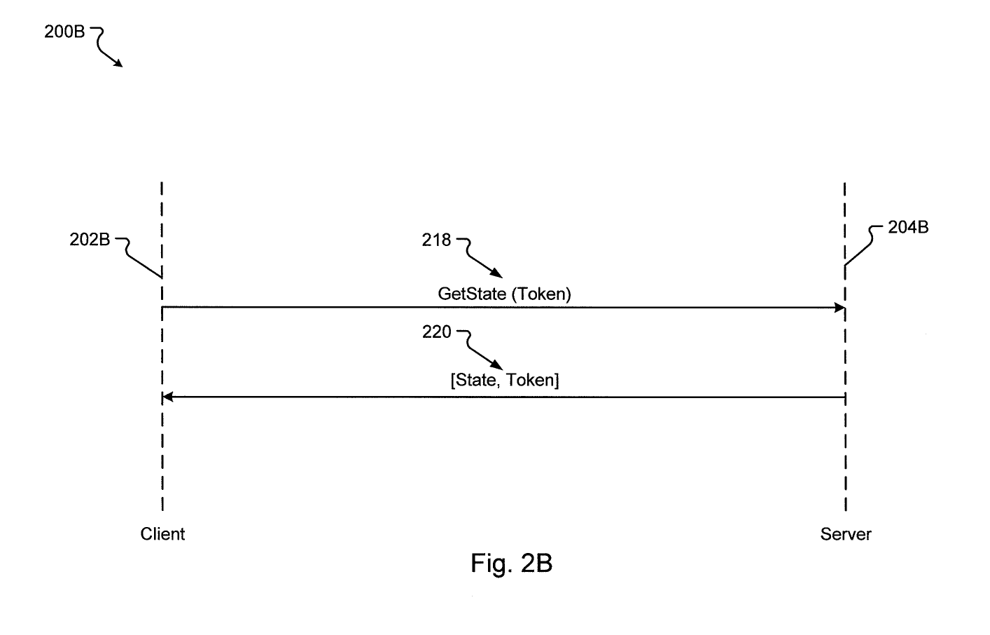

While FIG. 1B shows client computer 102 and servers 108-112 and 116-120, FIG. 2A depicts a logical representation 200A of software modules or components for using a token as a parameter of a long-held polling request for state updates, in accordance with embodiments of the present disclosure. Client computer 202A comprises a Web browser module 206 for polling server 204A for state updates. In other embodiments, client computer 202A polls server 204A without the use of Web browser module 206. Additional embodiments provide for client computer 202A to comprise further modules, including a user interface module 207 for executing on the client computer 202A to display a user interface for viewing Web pages, documents, data, etc. received from server 204A. Client computer 202A comprises other modules or components 210 as shown by ellipsis 208 for providing long polling via a token mechanism, in accordance with embodiments disclosed herein.

In response to receiving a long polling request for state updates via a token mechanism, server 204A analyzes the received request and token. In an embodiment, for example, server 204A comprises a management module 212 executing on server 204A. Management module 212 corresponds to manager module or component 122 in FIG. 1B, for example, and may be referred to by any name without departing from the spirit and scope of the present disclosure. Management module or component 212 receives state updates, such as from an application comprising a document editing session, for example. Management module 212 alters the state of the server 204A to reflect the state updates and hashes the state. The hashed state value is used to generate a token on the server reflecting the state of the server. Management module 212 uses the token on the server to compare to received token(s) from the client 202A to determine if the state data of the client is current, according to example embodiments. In embodiments, management module 212 thus provides for responding to the client request for state updates by evaluating the token value received from the client, for example. According to embodiments of the present disclosure, server 204A comprises other modules or components 216 as shown by ellipsis 214 for responding to long-held requests for state updates via a token mechanism.

Turning to FIG. 2B, a logical representation of an environment or system 200B for requesting state updates from client 202B to server 204B is shown in accordance with embodiments of the present disclosure. Client 202B, such as corresponding to client 202A in FIG. 2A, for example, sends a request 218 with a token as a parameter of the request 218 to server 204B. Server 204B corresponds to server 204A in FIG. 2A, for example. While request 218 is shown in FIG. 1A and FIG. 1B as comprising the HTTP request, “GetState,” any type of request may be used in accordance with embodiments of the present disclosure without departing from the spirit and scope of the present disclosure. In response, server 204B sends response message 220 comprising state data and the token on the server, according to embodiments, to client 202B. While FIG. 2B depicts a single request 218 and a single response 220, other embodiments provide for multiple request and response messages. Further, while embodiments provide for the request 218 to be a long-held request as part of a long polling technique via a token mechanism, other embodiments provide for a regular polling technique via a token mechanism. In yet a further embodiment, a request message 218 is sent from client 202B to server 204B without involving any type of polling technique. While FIGS. 2A and 2B depict example components and/or modules, these components and/or modules are offered for purposes of example only to illustrate the teachings of the present disclosure. Modules and/or components may be combined in embodiments. Further, additional or fewer modules and/or components may be used without departing from the spirit and scope of the present disclosure.

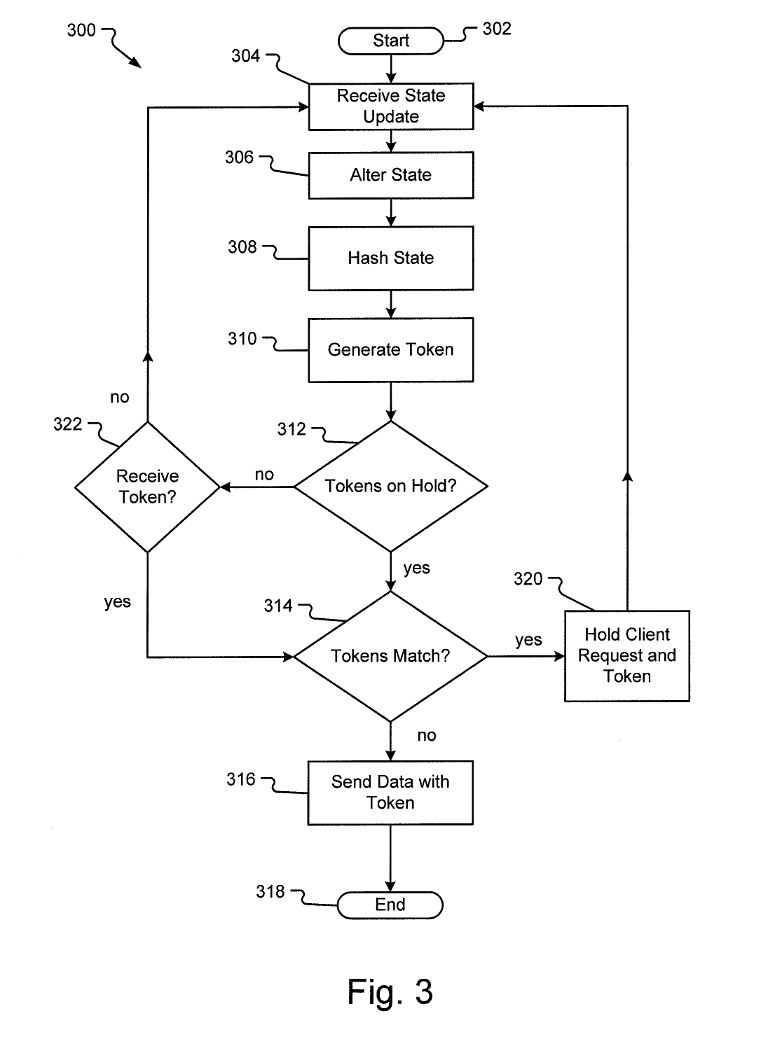

FIG. 3 next illustrates example operational steps 300 for determining whether to push state updates to a client and/or browser, in accordance with embodiments of the present disclosure. The example operational steps 300 depicted in FIG. 3 are shown from the perspective of a server and/or management component, according to an embodiment. Process 300 is initiated at START operation 302 and proceeds to receive state update 304, in which the server and/or management component executing on the server receives a state update 304, such as, for example, a change to a document and/or Web page from a document editing session. For example, an edit to a Web page may occur in a co-authoring session of an application program. The server next alters the state at the server 306 based on the received state update(s). In an embodiment, the server first determines if the received state update represents an actual change in the state data at the server. If an actual change to the state data results from the received state update, the state data of the server is changed 306, according to embodiments. Process 300 next proceeds to hash state operation 308, in which the state is hashed to generate a value for a token 310. In embodiments, this token is stored. Query 312 determines whether any tokens are on hold. For example, in embodiments involving long-held requests with long polling, for example, the server may have received a token from a client computer and/or browser in a request for state updates that is currently on hold with the server. If a token is on hold, process 300 proceeds YES to query 314 to determine whether the client token on hold matches the token on the server. If the tokens do not match, process 300 proceeds NO to send data with token 316, in which state data and the token value on the server are sent to the client 316. Process 300 then terminates at END operation 318.

Returning to query 312, if no tokens are on hold, process 300 proceeds NO to query 322 to determine if a token is received, such as from a client with a request for state updates. If a token is not received, process 300 proceeds NO to receive state update 304, in which the server may receive an additional change in state 304. Steps 304 then repeat to query 312. At query 322, if a token is received from a client, process 300 proceeds YES to query 314, in which it is determined whether the token on the server differs from the received token from the client. If the tokens match, process 300 proceeds YES to step 320 to hold the client request, e.g., long-held request, with the received token. Process 300 then proceeds to receive state update 304, and steps 304-312 then repeat. If the tokens do not match, process 300 proceeds NO to send state data with the token value on the server 316 to the client. Process 300 then terminates at END operation 318.

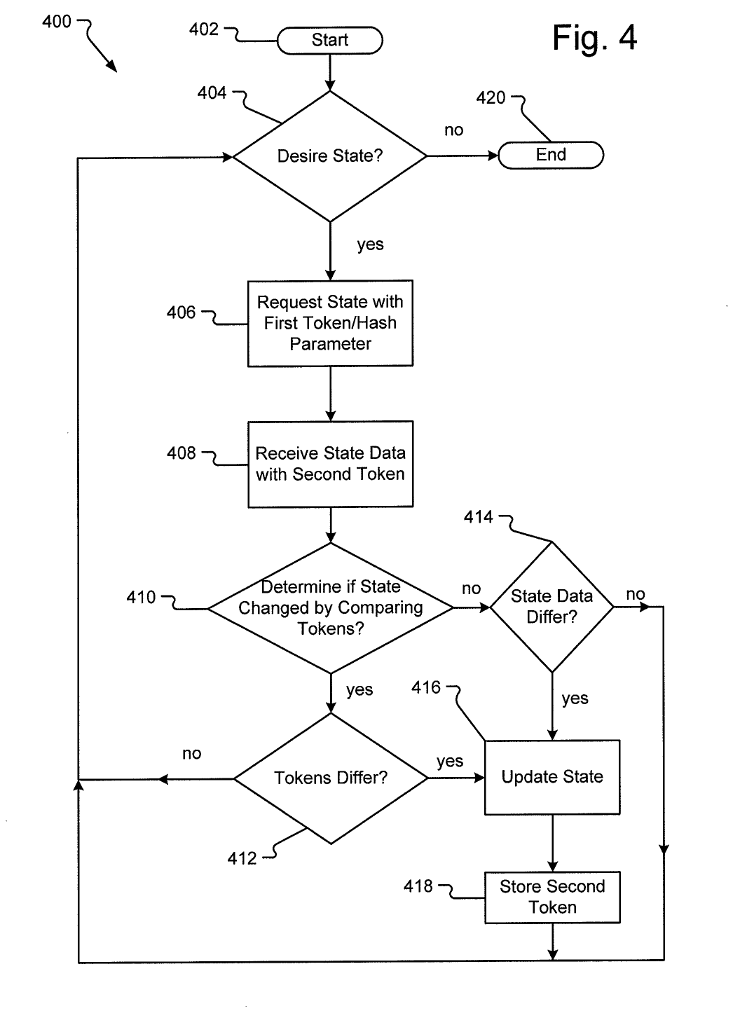

While FIG. 3 illustrates the example operational steps of a process for determining whether to push state updates, FIG. 4 depicts example operational steps for comparing tokens to determine if the state has changed, in accordance with an embodiment of the present disclosure. The example operational steps 400 depicted in FIG. 4 are shown from the perspective of a client and/or browser, according to an embodiment. Process 400 is initiated at START operation 402 and proceeds to desire state query 404, in which it is determined whether the client (and/or browser) desires the current state at the server. For example, the client may desire to know if it is in sync with the server, according to an embodiment. If the state at the server is not desired, process 400 proceeds NO to END operation 420, in which process 400 terminates. However, if the state at the server is desired, process 400 proceeds YES to request state with first token/hash parameter 406, in which the client sends a request to the server for the current state. In an embodiment, this request is a long-held request as part of a long polling technique to obtain state updates from the server. A first token, or client token, is sent with this request as a parameter of the request 406 according to embodiments of the present disclosure. For example, the client may have previously received a token value from the server, in which the client sends this token value as a request parameter to the server, in an embodiment. In another embodiment, the client sets the token value to an empty or random/default value or dummy value. In yet another embodiment, the token is sent separately from the client request.

In response to the request for state updates, the client receives state data with a second token 408. In an embodiment, the second token is the value of the token on the server, in which the value of the token on the server represents a hash of the current state at the server. Embodiments provide for the token on the server to be sent as a parameter of the response (comprising state data) to the client. In other embodiments, the token is sent separately from the state data. The client next determines 410 if it wants to compare the tokens to determine if there have been any state changes at the server. In embodiments, comparing the tokens provides a quick way for clients to examine if the state has changed from the previous state update. Clients may compare tokens instead of larger/more complex state data, for example. If the client desires to compare tokens, process 400 proceeds YES to query 412 to determine whether the tokens differ 412. If the tokens do not differ, e.g., they match, process 400 proceeds NO to query 404 to determine if the client desires to request state updates, and process 400 then repeats through steps 404-410, or terminates at END operation 420, according to embodiments. On the other hand, if the tokens differ, process 400 proceeds YES to update state 416, in which the client updates the state data 416 and stores 418 the second token, or token value received from the server at step 408, according to embodiments.

Returning to query 410, if the client does not desire to compare tokens to determine if there has been a state change, process 400 proceeds NO to query 414 to determine if the state data at the client differs from the state data received from the server at step 408. In embodiments, determining whether the state data differs is significantly more involved than determining if the tokens differ at query 412, for example. If the state data differs, process 400 proceeds YES to update state operation 416 and store second token 418, in which the client stores the token or token value received from the server to send with a subsequent request. In embodiments, the client blindly stores the second token and uses the received state data as the application demands. By storing the second token, the client may indicate its current state in a subsequent request to the server for state updates by including the second token as a parameter in the subsequent request. If the state data does not differ at query 414, process 400 proceeds NO to desire state query 404, and steps 404-410 repeat, or process 400 terminates at END operation 420, according to embodiments.

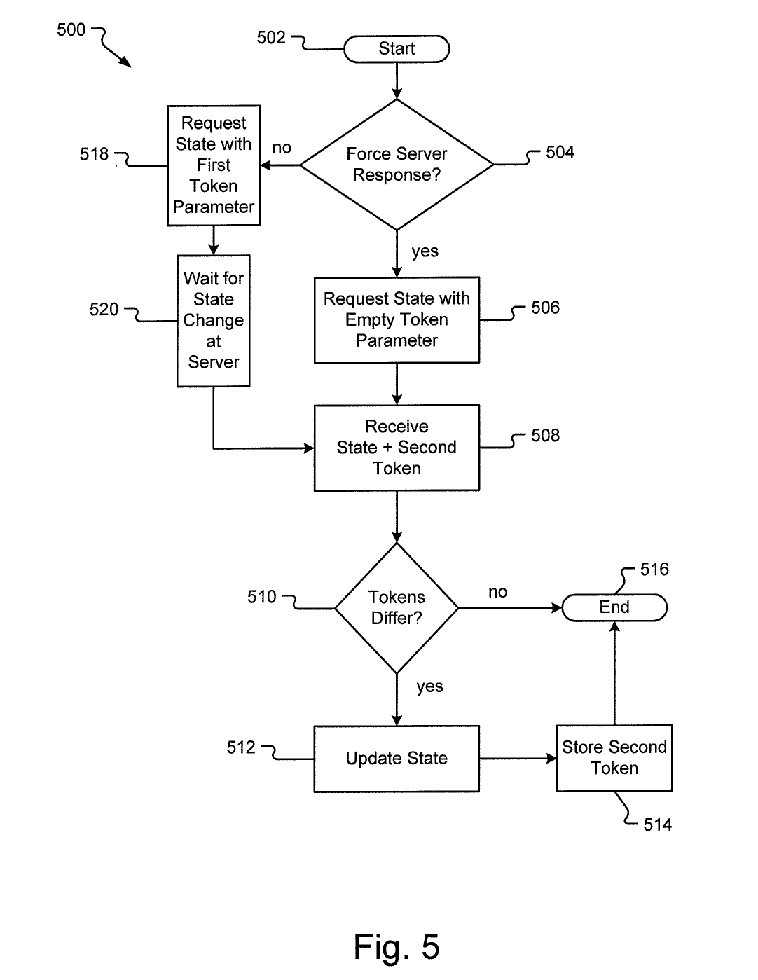

Turning to FIG. 5, example operational steps for forcing a response to a request for state updates are shown in accordance with embodiments of the present disclosure. The example operational steps 500 depicted in FIG. 5 are shown from the perspective of a client and/or browser, e.g., Web browser, according to an embodiment. Process 500 is initiated at START operation 502, and process 500 proceeds to query 504 to determine if a client (and/or browser, for example) desires to force a server response. In embodiments, the client may desire to force a response from the server where the client is aware that it is out of sync with the server, e.g., after a service interruption at the client. In other embodiments, the client desires to switch to regular polling, e.g., as achieved by repeatedly forcing a server response, where the client is on a portable computing device, such as a smartphone, for example, and plugs into a power source that enables polling, for example, in which polling typically is more computationally demanding and consumes more power. Or, as another example, a client may determine that polling is safer and may desire to poll periodically where the network is down or is experiencing frequent service interruptions. Further, a client may desire to switch from long polling to normal or regular polling to more gracefully handle errors that occur from server load or connection handling issues. Further yet, a client may desire to switch to polling, e.g., by forcing server responses, because long polling is simply not necessary in the environment the client is working in, for example, in a multi-user editing environment where the user is the only editor.

Where a server response is forced, this response may be sent immediately, according to embodiments. In other embodiments, the server responds according a predetermined time period. In yet further embodiments, the server responds in a time period determined by available system resources, for example. Numerous time periods for response by the server may apply in accordance with embodiments of the present disclosure without departing from the scope and spirit of the present disclosure.

Returning to FIG. 5, if the client desires to force a server response 504, process 500 proceeds YES to request state with empty token value 506, in which the client passes an empty value as a token value in the request for state updates. In another embodiment, the client passes a dummy value as the token value to force a state response. The client in such embodiments thus ignores the correct token value in sending an empty or random/default value or a dummy value. Or, in other embodiments, the client does not know the correct token value, such as when initiating a connection with a server, for example. Because the server receives an empty or random/default value or dummy value for the token value, the token on the server does not match the received token from the client, and the client therefore receives the actual state and the token value on the server 508. The token value on the server may be referred to as the token on the server, a second token, etc., without departing from the spirit and scope of the present disclosure. Process 500 next proceeds to query 510 to determine if the tokens differ 510, in which it is determined whether the token value at the client, e.g., a first token, differs from the token on the server, e.g., second token. If the tokens differ, the state at the server has changed since the client previously updated its state. In embodiments, the client is thus out of sync with the server. If it is determined that the tokens differ, process 500 proceeds YES to update state 512 and store second token 514. The state data received from the server is thus used to update the state at the client at step 512, and the token from the server is stored 514 to be used in a possible subsequent request for state updates at the server. Process 500 then terminates at END operation 516.

Returning to query 504, if the client does not desire to force a server response, process 500 proceeds NO to request state with first token value request parameter 518, in which the client does not use an empty or random/default value or dummy value as a token value but, instead, uses the correct token/hash value. As a result of using the correct token/hash, an immediate response from the server is not forced. Instead, the client waits, in embodiments, for a change in state to occur at the server 520. After a state change or update occurs at the server, the client receives the state, or state data, and a second token, or token value from the server, at step 508. Steps 510-514 then repeat, and process 500 terminates at END operation 516.

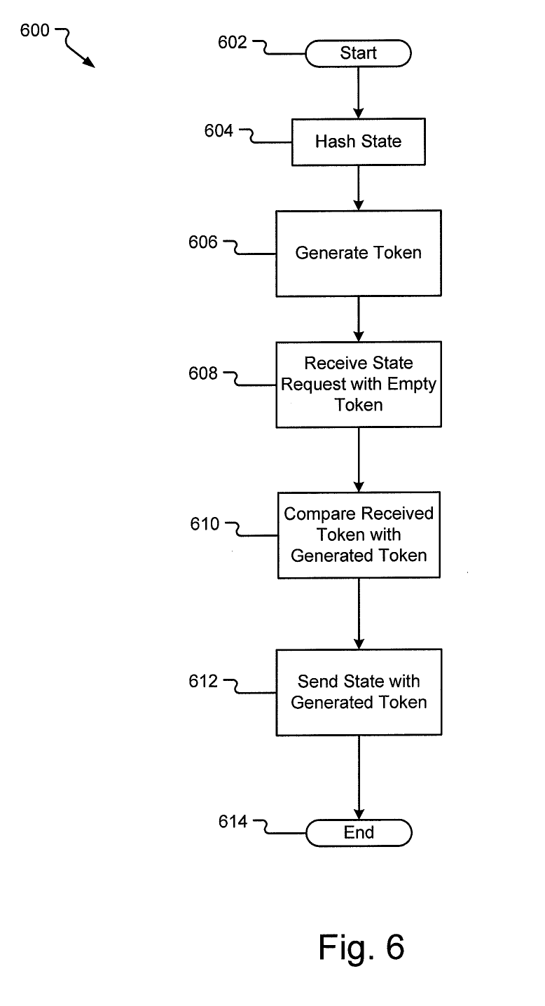

FIG. 6 next illustrates example operational steps for receiving an empty or random/default value as a token value to push data, in accordance with an embodiment of the present disclosure. The example operational steps 600 depicted in FIG. 6 are shown from the perspective of a server and/or management component or module, according to an embodiment. Process 600 is initiated at START operation 602 and proceeds to hash state operation 604, in which the state data at the server is hashed to generate a token of the hash value 606. Next, the server (and/or management module or component) receives a request for state updates with an empty or random/default value for the token value 608. In embodiments, such request is a long-held request as part of a long polling technique. In embodiments, the long polling technique comprises HTTP long polling. The server next compares 610 the received token or token value with the token generated at step 606. Because an empty or random/default token value or dummy value was included as a request parameter, the token on the server and the received token do not match, and the server therefore sends, or pushes, 612 state data with the token on the server generated at step 606. Process 600 then terminates at END operation 614.

While FIGS. 3-6 depict example operational steps, the operational steps shown may be combined into other steps and/or rearranged. Further, fewer or additional steps may be used, for example.

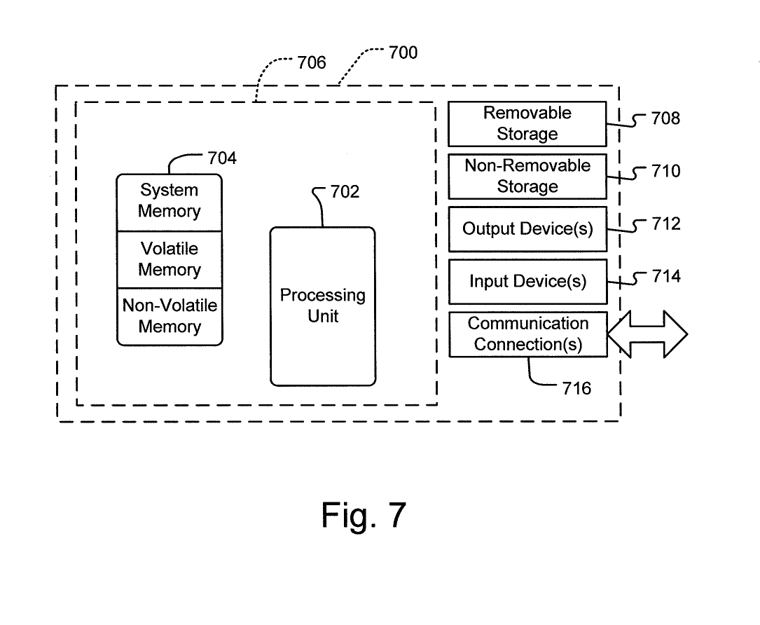

Finally, FIG. 7 illustrates an example computing system 700 upon which embodiments disclosed herein may be implemented. A computer system 700, such as client computer 102, front-end servers 108-112, and back-end servers 116-120, which has at least one processor 702, is depicted in accordance with embodiments disclosed herein. The system 700 has a memory 704 comprising, for example, system memory, volatile memory, and non-volatile memory. In its most basic configuration, computing system 700 is illustrated in FIG. 7 by dashed line 706. Additionally, system 700 may also include additional storage (removable and/or non-removable) including, but not limited to, magnetic or optical disks or tape. Such additional storage is illustrated in FIG. 7 by removable storage 708 and non-removable storage 710.

The term computer readable media as used herein may include computer storage media. Computer storage media may include volatile and nonvolatile, removable and non-removable media implemented in any method or technology for storage of information, such as computer readable instructions, data structures, program modules, or other data. System memory 704, removable storage 708, and non-removable storage 710 are all computer storage media examples (i.e., memory storage.) Computer storage media may include, but is not limited to, RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other medium which can be used to store information and which can be accessed by computing device 700. Any such computer storage media may be part of device 700. The illustration in FIG. 7 is intended in no way to limit the scope of the present disclosure.

The term computer readable media as used herein may also include communication media. Communication media may be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media.

System 700 may also contain communications connection(s) 716 that allow the device to communicate with other devices. Additionally, to input content into the fields of a User Interface (UI) on client computer 102, for example, as provided by a corresponding UI module (not shown) on client computer 102, for example, in accordance with an embodiment of the present disclosure, system 700 may have input device(s) 714 such as a keyboard, mouse, pen, voice input device, touch input device, etc. Output device(s) 712 such as a display, speakers, printer, etc. may also be included. All of these devices are well known in the art and need not be discussed at length here. The aforementioned devices are examples and others may be used.

Having described embodiments of the present disclosure with reference to the figures above, it should be appreciated that numerous modifications may be made to the embodiments that will readily suggest themselves to those skilled in the art and which are encompassed within the scope and spirit of the present disclosure and as defined in the appended claims. Indeed, while embodiments have been described for purposes of this disclosure, various changes and modifications may be made which are well within the scope of the present disclosure.

Similarly, although this disclosure has used language specific to structural features, methodological acts, and computer-readable media containing such acts, it is to be understood that the subject matter defined in the appended claims is not necessarily limited to the specific structure, acts, features, or media described herein. Rather, the specific structures, features, acts, and/or media described above are disclosed as example forms of implementing the claims. Aspects of embodiments allow for multiple client computers, multiple front-end servers, multiple back-end servers, and multiple networks, etc. Or, in other embodiments, a single client computer with a single front-end server, single back-end server, and single network are used. Further embodiments provide for a single client computer with a single front-end server and no back-end server, for example. One skilled in the art will recognize other embodiments or improvements that are within the scope and spirit of the present disclosure. Therefore, the specific structure, acts, or media are disclosed as example embodiments of implementing the present disclosure. The disclosure is defined by the appended claims.

What is claimed is:

1. A computer-implemented method for pushing state data to a client, the method comprising:
receiving a state update at a server;
in response to receiving the state update, altering the state at the server;
hashing the state at the server;
generating a token on the server, wherein the token is the hash of the state;
receiving a token from the client;
determining if the token on the server and the received token from the client differ; and
if the token on the server and the received token from the client differ, pushing state data with the token on the server to the client.

2. The computer-implemented method of claim 1, wherein the determining if the token on, the server and the received token from the client differ comprises determining if a value of the token on the server and a value of the received token from the client differ.

3. The computer-implemented method of claim 1, further comprising:
receiving, from the client, a request for a state update, wherein the received token from the client is a parameter of the request for a state update.

4. The computer-implemented method of claim 3, further comprising:
if the token on the server and the received token from the client do not differ, holding the received request and the received token from the client.

5. The computer-implemented method of claim 3, wherein a value of the received token from the client is empty.

6. The computer-implemented method of claim 5, further comprising:
determining the token on the server and the received empty token value from the client differ; and
pushing state data with the token on the server to the client.

7. The computer-implemented method of claim 5, further comprising:
in response to the empty value, pushing the state data with the token on the server to the client in a predetermined time period.

8. The computer-implemented method of claim 1, wherein the state data pushed to the client comprises the received state update.

9. The computer-implemented method of claim 1, wherein the state update is received from an application comprising a document editing session.

10. One or more computer storage media storing computer-executable instructions that when executed by a processor perform a method for polling a server for state data, the method comprising:
sending, by a client, a first request for the state data at the server, wherein the first request comprises a first token;
receiving the state data with a second token;
comparing the first token and the second token to determine if the received state data differs from state data stored at the client; and
if the first token and the second token differ, updating the state data stored at the client.

11. The one or more computer storage media of claim 10, wherein the polling comprises Hypertext Transfer Protocol (HTTP) long polling via a token mechanism.

12. The one or more computer storage media of claim 10, further comprising:
if the first token and the second token differ, storing the second token at the client.

13. The one or more computer storage media of claim 12, further comprising:
sending a second request for the state data at the server, wherein the second request comprises the second token;
in response to the second request, receiving the state data with a third token;
comparing the second token and the third token to determine if the received state data differs from state data stored at the client; and
if the second token and the third token differ, updating the state data stored at the client.

14. The one or more computer storage media of claim 10, wherein the first token comprises a random value.

15. The one or more computer storage media of claim 14, wherein the random value is passed in the first token to force a response from the server, and wherein the response from the server is received in a predetermined period of time.

16. The one or more computer storage media of claim 10, wherein the received state data comprises one or more state updates.

17. A system for pushing state data at a server to a client via a token mechanism, the system comprising:
a processor; and
memory coupled to the processor, the memory comprising computer program instructions executable by the processor to provide:
a management module within the server, wherein the management module is configured to:
receive a state update;
in response to receiving the state update, alter the state;
hash the state;
generate a token on the server, wherein the token is the hash of the state;
receive a token from the client;
determine if the token on the server and the received token from the client differ; and
if the token on the server and the received token from the client differ, push state data with the token on the server to the client.

18. The system of claim 17, further comprising:
if the token on the server and the received token from the client do not differ, holding the received token from the client.

19. The system of claim 17, wherein the state update is received from an application comprising a document editing session.

20. The system of claim 17, wherein a value of the received token from the client is empty, and wherein, in response to the empty value, the state data is pushed to the client in a predetermined period of time.
